(19) United States
(12) Patent Application Publication
(10) Pub. No.: US 2009/0240853 A1
(43) Pub. Date: Sep. 24, 2009

(54) Method and apparatus for configuring a bus network in an asset management system

(75) Inventor: Christopher E. Piggott, Pittsford, NY (US)

Correspondence Address: NIXON PEABODY LLP - PATENT GROUP, 1100 CLINTON SQUARE, ROCHESTER, NY, 14604, US

(73) Assignee: Rochester Institute of Technology

(21) Appl. No.: 12/077,774

(22) Filed: Mar. 21, 2008

(51) Int. Cl. G06F 13/00

(52) U.S. Cl. 710/104

(57) ABSTRACT

A method and system for managing assets includes a controller area network bus having a first end and a second end. One or more sensor systems are connected to the network bus. The sensor systems are connected to one or more assets to obtain at least one of operational data and condition data for the one or more assets. A self-healing bridge is connected to the first end and the second end of the network bus and is adapted to minimize a loss of connectivity in the network bus.

### FEDERALLY SPONSORED RESEARCH OR DEVELOPMENT

The subject invention was made with government support under Grant No. N00014-05-1-0708, awarded by the Office of Naval Research. The U.S. Government may have certain rights. The U.S. Government has a paid-up license in this invention and the right in limited circumstances to require the patent owner to license others on reasonable terms as provided for by the terms of Grant No. N00014-05-1-0708.

### FIELD OF THE INVENTION

The present invention relates generally to methods and systems for configuring a bus network, and more particularly, to configuring a bus network with a self-healing bridge in an asset management system.

### BACKGROUND

Existing systems for asset management are mostly ad-hoc, and only take into account short term operations planning based on recent maintenance history. Systems can require long-term monitoring to assess certain assets of the system. Asset management systems having bus network architecture may not be suitable for electromechanical systems in which continuous or near-continuous communication within the system is desirable. A physical break in a cable of an asset management system that uses bus architecture will lead to a loss in connectivity that causes a communication loss from the point of the break to the end of the bus.

### SUMMARY

According to one aspect of the invention, a system for managing assets includes a controller area network bus having a first end and a second end. One or more sensor systems are connected to the network bus. The sensor systems are connected to one or more assets to obtain at least one of operational data and condition data for the one or more assets. A self-healing bridge is connected to the first end and the second end of the network bus and is adapted to minimize a loss of connectivity in the network bus.

According to another aspect of the invention, a method for minimizing a loss of connectivity in a controller bus area network bus for an asset management system includes connecting a self-healing bridge to a first end and a second end of the network bus. The self-healing bridge has a plurality of interfaces. Communication packets are transmitted along the network bus. One or more of the plurality of interfaces are monitored for the communication packets. If the communication packets are not received at the monitored plurality of interface, the transmission received by one of the interfaces is repeated at one of the other interfaces.

According to another aspect, a system for minimizing a loss of connective in an asset management system includes a plurality of sensor systems connected to a plurality of controller area network buses. Each network bus has a first end and a second end. A plurality of assets have one or more of the plurality of sensors system connected to them. The sensor system is adapted to obtain at least one of operational data and condition data for the plurality of assets. A self-healing bridge is connected to the first end and the second end of each network bus. Each self-healing bridge is adapted to minimize a loss of connectivity in the network buses.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a block diagram of an asset management system in accordance with one embodiment of the present invention;

FIG. 2 is a block diagram of a controller area network bus having one or more assets in accordance with other embodiments of the present invention; and

FIG. 3 is a block diagram a self-healing bridge incorporated into a controller area network bus having one of more assets in accordance with other embodiments of the present invention; and

FIG. 4 is a block diagram further illustrating the self-healing bridge from FIG. 3.

### DETAILED DESCRIPTION

While this invention is susceptible of embodiment in many different forms, there is shown in the drawings and will herein be described in detail certain embodiments of the invention with the understanding that the present disclosure is to be considered as an exemplification of the principles of the invention and is not intended to limit the broad aspect of the invention to the embodiments illustrated.

Asset management systems enhance command and control effectiveness, improve maintenance and supply logistics, and reduce operations and support costs, for platforms that incorporate the technology. An asset health management system is a data acquisition network for measuring the health and performance of complex electromechanical systems. Asset health management technology can be applied to military and non-military platforms, such as ships, aircraft, ground vehicles, and a variety of electromechanical systems including engines and industrial equipment. An asset health management system can include a sensor network, software components, data storage capabilities and an information network. The sensor network gathers data from sensors and transmits the data to software components that read and process the sensor data. The sensor network can further provide data storage using, for example, a database. The information network allows access to data in the database through the use of external systems and can further allow the performance of administrative activities.

An asset health management system can include various hardware components including a system health node having a central processor and information store for providing high-level diagnostic and prognostic assessments for the host platform (e.g., ground vehicle, air plane, ship, industrial equipment). The asset health management system can further include data acquisition nodes and operator interface devices. The components of an asset management system communicate using a controller area network (CAN) (e.g., J1939-compatible) data bus in which one cable can provide both bus communication and distributed power for the various nodes. In certain embodiments, the communication and power elements can be delivered using separate cables or alternate communication and power delivery systems. The cable comprises separate shielded sections for communications and power, and may also include multiple grounds to fully isolate the controller area network and power. A centralized power supply and conditioner can be used to feed the data bus.

Controller area networks are often used in vehicle data networks and in industrial automation systems. An example of a controller area network in a motor vehicle can include a data bus having a cable with two wires and a power source. The data bus is distributed to various components throughout the vehicle. That is, instead of distributing numerous separate wires to a component of a motor vehicle (e.g., a door), a single controller area network bus can be connected to, for example, the power mirror, power windows, power door locks, and the lights on the door of the vehicle. Digital communication packets can then be sent along the controller area network bus that are specific to one or more of the individual components. The packets can include an instruction, such as, for example, to lock or unlock the door lock.

An asset management system can also include algorithms for: (i) gathering data from a data carrying network, (ii) processing data on multiple levels to identify system anomalies, and (iii) making diagnostic and prognostic assessments. If the system detects an anomaly, the host platform user can be notified, through communications with the operator interface device, so that corrective action, if any, can be made. Data that is stored by the system (e.g., in a database) can also be transferred to an external system for further analysis or long-term storage. The transfer of data can be done manually using physical media or automatically over a network.

In certain embodiments, sensors positioned at various nodes in the asset management system measure voltages at various monitoring points to provide data, such as pressure, fluid level, temperature, or perhaps vibration information, for an asset that is being monitored. The data from the sensors are then collected through the asset health management system and processed to make a health assessment of the asset. For example, if the host platform for the asset health management system is a military ground vehicle, a sensor that monitors oil temperature in an asset, such as the engine, can be used on its own, or in conjunction with data from other sensors, to determine if the asset is failing or has a limited remaining useful life. After assessing the health of the asset, the asset health management system may then alert the vehicle operator so that appropriate action may be taken, such as aborting a mission, making a quick repair, calling ahead for parts, etc.

In certain embodiments, asset management systems are used prognostically to determine the remaining life of an asset. Data can be assessed from one or more sensors to predict failures in advance or to notify an operator how long before a failure will occur. The predictions can be based on statistics and trends, along with the running history data collected from the sensors. In one example, an asset health management system can monitor and update the remaining useful life of a vehicle battery following the failure of an alternator. The asset health management system may deliver a report to a display for the vehicle operator that indicates the alternator has failed. The report may also indicate that under current conditions the battery has 6 hours of remaining useful life. Shortly thereafter, the operator may need to turn on the headlights, which adjusts the electrical load the vehicle is experiencing. The asset health management system may then provide an update telling the operator that under the revised electrical load, only 3 hours of useful life remains in the battery.

Asset management systems can continually record and store the history of sensor readings taken for the various assets of a vehicle. For example, an asset management system may keep a running history of the oil temperature of a vehicle to determine what happens both prior to, during and after a particular condition or event (e.g., driving up a hill) is experienced by the vehicle. The asset management system may be linked to other systems in the vehicle that assess other vehicle parameters indicative of whether a condition or event is occurring. Under certain conditions or events (e.g., driving uphill), an increase in oil temperature may be considered normal or expected. However, for other conditions or event (e.g., driving downhill or on a solid, flat terrain), the increase in oil temperature may not be normal or expected, which can trigger the system to report an anomaly in the asset.

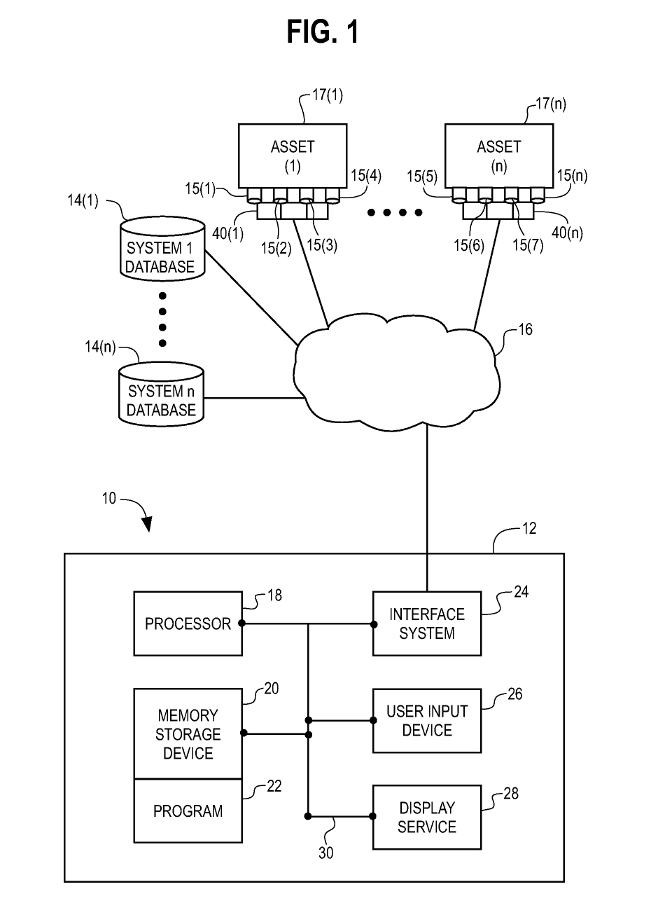

Referring now to FIG. 1, an embodiment of an asset management system 10 is described. The asset management system can have one or more assets 17(1)-17(n) and can include a processing system 12, database(s) 14(1)-14(n), sensor(s) 15(1)-15(8), and a communication system 16. The asset management system 10 can include other types and numbers of systems and components arranged in other manners. Other examples of asset management systems are disclosed in U.S. Patent Publication No. 2006/0282362 A1, published on Dec. 14, 2006, entitled “Methods For Asset Health Management And Systems Thereof”, which is herein incorporated by reference in its entirety.

The processing system 12 is used to determine an optimization plan or instruction(s) for one or more of the assets 17(1)-17(n) based on information, such as diagnostic testing, prognostic testing, cost data, and/or allocation data, although other types and numbers of optimization processing system 12 could be used. For example, the optimization processing system 12 could be coupled to a higher level system which managed the optimization processing system 12 along with other optimization processing systems for other assets.

The processing system 12 includes at least one processor 18, at least one memory 20, at least one memory storage device 20 which stores programmed instructions, at least one interface system or device 24, at least one user input device 26, and at least one display device 28 which are coupled together by a bus system 30 or other link, although the processing system 12 may comprise other components, other numbers of the components, and other combinations of the components. In this particular embodiment, the processor 18 executes a program 22 of stored instructions in memory storage device 20 for at least a portion of the method for optimizing utilization of one or more assets 17(1)-17(n). The memory storage device 20 stores these programmed instructions, including program 22 in a memory device, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor 18. In certain embodiments, the programmed instructions in the processing system 12 that are executed by the processor 18 may be stored or executed elsewhere within the system or external to the system. The input/output interface 20 is used to operatively couple and communicate between the processing system 12 and the component information system 14. The user input device 23 enables an operator to generate and transmit signals or commands to the processor 18, such as inputting data or requests for data about components, although the user input device is optional. A variety of different types of user input devices can be used, such as a keyboard or computer mouse. The display device 28 enables the operator to observe displayed data information, such as the optimization plan or instruction(s). A variety of different types of display devices can be used, such as a CRT or a printer.

The databases 14(1)-14(n) store data, such as historical maintenance data, life cycle data, specifications, performance, and status, for each of the elements of each of the assets 17(1)-17(n). These databases 14(1)-14(n) can be supplemented on an ongoing basis with additional data, such as historical maintenance data, life cycle data, obtained from the management and optimization of the assets 17(1)-17(n). For example, one of the databases 14(1)-14(n) may store tables or graphs showing the expected time to failure versus the usage of an element in one of the assets, which can be utilized in determining an optimization plan or instructions(s).

The sensors 15(1)-15(n) are coupled to the processing system 12 via communication system 16, although data from the sensors 15(1)-15(n) can be provided to the processing system 12 in other manners, such as by being input into processing system 12 using user input device 26. The sensors 15(1)-15(n) monitor and provide data about the operation and condition of elements in each of the assets 17(1)-17(n), such as performance data, temperature readings, detected failures, images. In this particular embodiment, sensors 15(1)-15(3) are each coupled to different elements in asset 17(1) and sensors 15(5)-15(n) are each coupled to different elements in asset 17(n), although other numbers and types of sensors for each of the assets 17(1)-17(n) can be used. A variety of different types and numbers of assets 17(1)-17(n) can be managed, such as automobiles, tanks, planes, machines, etc. and a variety of different elements in each asset can be monitored.

Communication system 16 is used to control and manage communication between processing system 12, databases 14(1)-14(n), and sensors 15(1)-15(n). The embodiment of FIG. 1 illustrates a wireless network, although other types and numbers of communication systems and/or methods can be used, such as a direct connection, Ethernet, a local area network, a wide area network, or modems and phone lines, each having communications protocols.

In certain embodiments, the elements of the asset management system, including processing system 12, databases 14(1)-14(n) and the sensors 15(1)-15(n), can be linked together through a controller area network bus to monitor assets 17(1)-(n). The elements can be linked individually (e.g., sensors 15(1)-(3)), collectively (e.g., processing system 12, databases 14, sensors 15) or in some combination thereof (e.g., processing system 12 in one CAN bus and sensors 15(1)-(n) in another CAN bus). In the embodiment illustrated in FIG. 1, a controller area network data bus is used for bus system 30, which links the elements of processor system 12. Sensors 15(1)-(3) and 15(5)-(n) are linked by a first sensor bus 40(1) and an n-th sensor bus 40(n), all of which can be controller area network buses. The sensors 15(1)-(n) used to monitor assets 17(1)-(n) can all be linked together using a single controller area network bus or a series thereof (e.g., sensor buses 40(1)-(n)).

A controller area network bus can be configured as a straight line system that can be continuously wired throughout a host platform (e.g., vehicle) so that sensor(s) monitoring particular assets of concern (e.g., engine, tire, battery) can be connected to the bus. The controller area network can then monitor and record readings from the sensors 15. The sensor bus 40 can comprise two twisted wires within a bus cable that is placed throughout within the host platform.

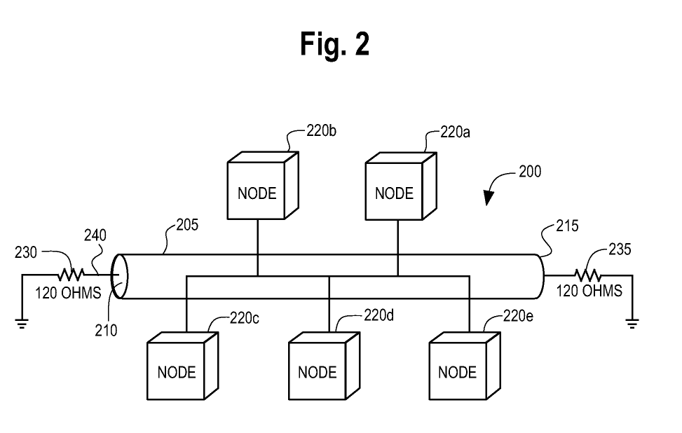

Referring now to FIG. 2, a controller area network bus 200 is illustrated that has a number of nodes 220a-e distributed along a main trunk 205 of bus 200. The controller area network bus 200 has a first end 210 and a second end 215 that terminate with 120-ohm resistors 230, 235. While the schematic of FIG. 2 only shows a single line, the controller area network bus 200 includes two wires 240 than can be twisted together or distributed otherwise along the bus 200. One wire can be identified as controller area network high (CAN high) and the other wire can be identified as controller area network low (CAN low). The resistors 230, 235 (e.g., 120 ohm) can be placed in between the CAN high and CAN low wires 240. In certain embodiments, a split resistor (e.g., two 60-ohm resistors) can be used. Other resistor combinations may be used, as well.

Nodes 220a-e are distributed along the main trunk 205 and a node can represent a single sensor for individually monitoring a certain asset of the host platform for the asset management system. In other embodiments, a group of nodes (e.g., 220a-c) can include varying quantities of sensors for which the group of nodes (e.g., 220a-c) together can monitor a particular asset. In certain embodiments, each node 220a-e can represent a single asset that is being monitored by one or more sensors associated with a particular node 220a-e.

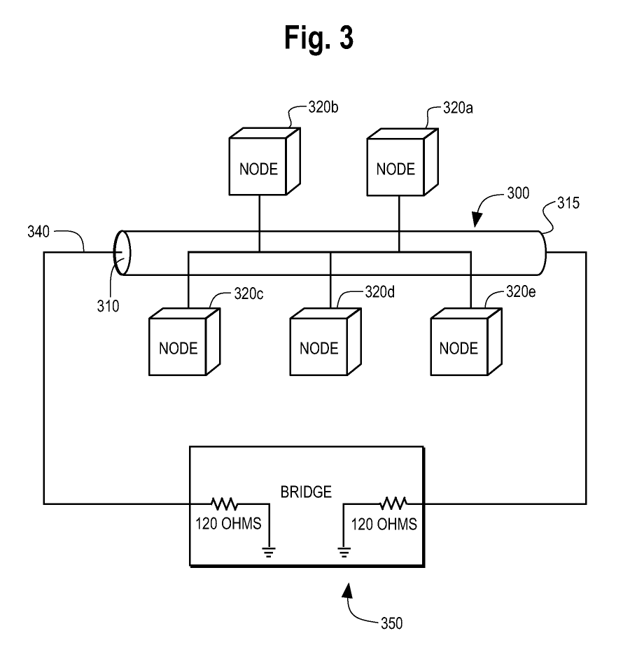

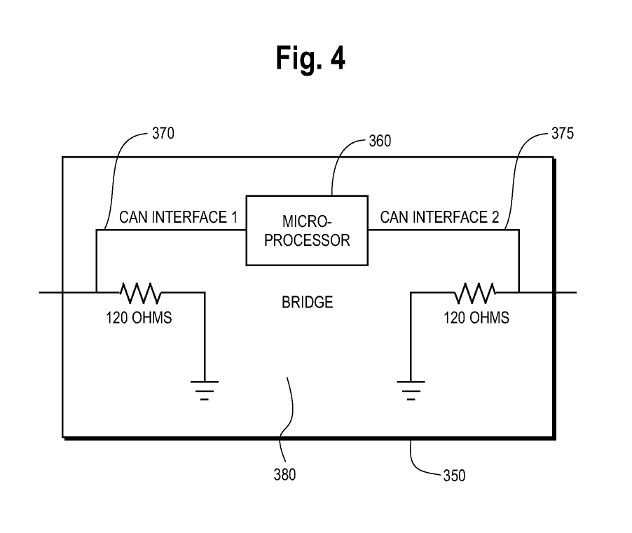

Turning now to FIGS. 3-4, a self-healing bridge 350 is illustrated as part of controller area network bus 300. The self-healing bridge 350 provides a connection between the first end 310 and second 315 of the controller area network bus 300, similar to a ring or loop. The controller area network bus architecture illustrated in FIG. 3 allows the controller area network bus 300 to self-heal in the event of a loss of connectivity in the middle of the bus 300. The architecture of FIG. 3 can be integrated so that a series of controller area network buses 300 are linked together with each having a self-healing bridge 350. Furthermore, the architecture illustrated in FIG. 3 allows continuous monitoring and communication with the nodes while minimizing having to add self-healing intelligence at each of the individual nodes 320a-e.

FIG. 4 illustrates the self-healing bridge from FIG. 3 in greater detail. The self-healing bridge 350 can be an intelligent device having, for example, a microprocessor 360 capable of detecting whether there is a break in one of the wires 340 of the controller area network bus 300. If the microprocessor 360 detects a break in a wire 340, the digitally communicated information from broken side of the loop can be communicated to the other connected side of the loop. In one example, the controller area network bus can comprise a circle or loop network in which a break anywhere along the line still allows communication access by repeating the digital communication via the opposite path of the circle.

The microprocessor 360 inside the self-healing bridge 350 has two separate controller area network interfaces 370, 375, which allows the microprocessor to participate in communications in the controller area network bus 300 from both the first end 310 and the second end 315. In certain embodiments, algorithms operating on the microprocessor 360 can detect a break in the wires of the bus 300, and if a break is detected, the microprocessor 360 can begin repeating messages from one interface 370 to the other 375, or the other way around.

A break in the wires of the controller area network bus 300 can be detected either actively or passively. For active detection, the microprocessor 360 can transmit a periodic signal out of at least one of the interfaces 370, 375 or from an alternate interface (not shown). For example, in a diagnostic or monitoring application, the signal may be transmitted on the order of approximately once every second from an interface. For application(s) where additional attention is desirable, a signal may be transmitted more frequently, such as, for example, on the order of ten times a second or more. The expectation is that the periodic signal will be received on at least one of the other interfaces. If the periodic signal is not detected at either interface 370 or interface 375, a break in the wires or loss in connectivity has occurred in the controller area network bus 300.

For passive detection of a break in the wires of the controller area network bus 300, each interface 370, 375 is listening or receiving digital communication packets and a list of the packets received is compiled for each interface 370, 375 of the microprocessor 360. In one embodiment, the listening or receiving of digital communication packets includes looking at every packet traveling along the controller area network bus 300. Under normal operating conditions (e.g., no break in the wires), the communication packets appear on both controller area network interfaces 370, 375 nearly simultaneously. Some delay may be encountered in the receipt of the communication packets at each interface due to software latency issues. If a communication packet is only received at one of the interfaces 370, 375, a loss of connectivity has occurred in the controller area network bus 300.

It is desirable when using active and passive detection to establish algorithms in the microprocessor that take into account that not all communication packets are always delivered on a controller area network bus. For example, certain communication packets can have priority over others. The microprocessor 360 can have an algorithm that accounts for lost communication packets by requiring the detection (or lack thereof) of a certain number of lost messages before concluding that a break in the wires of the controller area network bus 300 has occurred.

When a break is detected in the bus 300, the bridge 380 can start repeating digital communication packets in both directions of the network bus between the controller area network interfaces 370, 375. Break detection can continue throughout the period after the break so that a determination can be made if the break was repaired (e.g. someone reconnected the wires of the bus). In certain embodiments, a break detection mode can switch to active detection once a break is detected. The periodic break detection signal can also be given a high-priority controller area network identification to allow quicker detection of whether the break has been repaired.

In certain embodiments, it can be desirable to have multiple self-healing bridges, such as, the bridge illustrated in FIGS. 3-4. In this configuration, one of the self-healing bridges can be configured to be an “end” node, meaning that the bridge operates as described for bridge 350 in FIGS. 3-4 (that is, communication packets are repeated if a line break is detected). The other self-healing bridges can be configured as “slave” nodes, meaning that the remaining bridges operate by continually repeating all the communication packets. An advantage of using multiple self-healing bridges is that it allows more of the nodes in an asset management system to communicate with the processing system were a break in the wires of the bus to occur.

Having thus described certain embodiments of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Further, the recited order of elements, steps or sequences, or the use of numbers, letters, or other designations therefore, is not intended to limit the claimed processes to any order except as may be explicitly specified in the claims. Accordingly, each of the embodiments and obvious variations thereof are contemplated as falling within the spirit and scope of the claimed invention, which is set forth in the following claims.

1. An asset management system, the system comprising:
a controller area network bus having a first end and a second end;
one or more sensor systems connected to said network bus;
one or more assets, said sensor systems connected to said one or more assets to obtain at least one of operational data and condition data for said one or more assets;
a self-healing bridge connected to said first end and said second end, said self-healing bridge configured to minimize a loss of connectivity in said network bus.

2. The system of claim 1, wherein said self-healing bridge further includes a microprocessor.

3. The system of claim 2, wherein said self-healing bridge has a first interface and a second interface connected to said microprocessor, said first interface and said second interface configured to transmit and receive communication packets along said network bus such that a communication packet received by said first interface is transmitted from said second interface and a communication packet received by said second interface is transmitted from said first interface.

4. The system of claim 2, wherein the microprocessor detects for a loss of connectivity in said network bus.

5. The system of claim 4, wherein the microprocessor has a first interface and a second interface, said microprocessor operable to repeat at said second interface communication packets received at said first interface if a loss of connectivity is detected.

6. The system of claim 1, wherein said self-healing bridge uses passive detection to detect for loss of connectivity in said network bus.

7. The system of claim 6, wherein said passive detection is continuous.

8. The system of claim 6, wherein said passive detection comprises continuously receiving communication packets at a plurality of interfaces connected to a microprocessor in said self-healing bridge, said loss of connectivity established when said communication packet is not received by at least one of said interfaces.

9. The system of claim 1, wherein said self-healing bridge uses active detection to detect for loss of connectivity in said network bus.

10. The system of claim 9, wherein said active detection is continuous.

11. The system of claim 9, wherein said self-healing bridge includes a microprocessor, said active detection comprising transmitting a periodic signal out of an interface connected to said microprocessor, said signal moving through said network bus, and if there is no loss of connectivity in said network bus, said signal is received at another interface connected to said microprocessor.

12. The system of claim 1, further including a display configured to display that a loss of connectivity occurred in said network bus.

13. A method for minimizing a loss of connectivity in a controller bus area network bus for an asset management system, the method comprising:
connecting a self-healing bridge to a first end and a second end of said network bus, said self-healing bridge having a plurality of interfaces;
transmitting communication packets along said network bus;
monitoring one or more of said plurality of interfaces for said communication packets; and
if said communication packets are not received at said monitored plurality of interfaces, repeating said transmission of said communication packets received by one of said interfaces at another one of said interfaces.

14. The method of claim 13, wherein said monitoring of said one or more plurality of interfaces is continuous.

15. The method of claim 13, wherein said monitoring of said one or more plurality of interfaces is active.

16. The method of claim 15, wherein said active monitoring comprises transmitting a periodic monitoring signal out of one of the plurality of interfaces, said signal moving through said network bus, and if there is no loss of connectivity in said network bus said signal is received at another monitored interface.

17. A system for minimizing a loss of connective in an asset management system, the system comprising:
a plurality of sensor systems connected to a plurality of controller area network buses, each network bus having a first end and a second end;
a plurality of assets having said one or more of said plurality of sensors system connected thereto, said sensor system configured to obtain at least one of operational data and condition data for said plurality of assets;
a self-healing bridge connected to said first end and said second end of each network bus, each self-healing bridge configured to minimize a loss of connectivity in said network buses.

18. The system of claim 17, wherein at least one of the self-healing bridges includes a microprocessor having a first interface and a second interface connected thereto for detecting a loss of connectivity in said network bus.

19. The system of claim 18, wherein if a loss of connectivity is detected, said microprocessor is operable to repeat at said second interface communication packets received at said first interface.

20. The system of claim 17, wherein at least one of said self-healing bridges uses passive detection to detect for loss of connectivity in said network bus.

21. The system of claim 20, wherein said passive detection is continuous.

22. The system of claim 17, wherein at least one of said self-healing bridges uses active detection to detect for loss of connectivity in said network bus.

23. The system of claim 22, wherein said active detection is continuous.

24. The system of claim 17, further including a display configured to display that a loss of connectivity occurred in at least one of said network buses.
